(19) United States
(12) Patent Application Publication
(10) Pub. No.: US 2020/0058078 A1
(43) Pub. Date: Feb. 20, 2020

(54) EXPENSE CALCULATION BASED ON EVENT DATA

(71) Applicant: Taxlendar Inc., Sunnyvale, CA (US)

(72) Inventors: Ye Jane Li, Los Altos Hills, CA (US); Xinqi Pan, Freemont, CA (US); Pengyu Ren, Beijing (CN)

(21) Appl. No.: 16/541,552

(22) Filed: Aug. 15, 2019

Related U.S. Application Data
(60) Provisional application No. 62/719,285, filed on Aug. 17, 2018.

(51) Int. Cl. G06Q 40/00; G06F 16/2457; G06Q 10/10; G06N 20/00; G06N 5/04

(52) U.S. Cl. CPC G06Q 40/123; G06F 16/2457; G06N 5/04; G06N 20/00; G06Q 10/1095

(57) ABSTRACT

Described herein are systems, methods, and software to provide an expense calculation based on calendar event data. In one implementation, a method of operating a computing system includes receiving one or more calendar events indicating an event type, a location, a date, and a time associated with each of the one or more calendar events. At least one of the one or more calendar events is identified as qualifying for mileage tracking based on the event type associated with the calendar event. A user is determined to be located at the location associated with the qualifying calendar event at the identified date and time associated with the qualifying calendar event. An estimated mileage calculation is then provided based at least in part on the location associated with the qualifying calendar event.

### RELATED APPLICATIONS

This claims priority to and benefit from U.S. Provisional Patent Application Ser. No. 62/719,285, filed on Aug. 17, 2018, titled “Expense Calculation Based on Calendar Event Data,” which is expressly incorporated by reference herein.

### TECHNICAL FIELD

Aspects of the disclosure are related to computing hardware and software technology, and in particular to provide an expense calculation based on event data.

### TECHNICAL BACKGROUND

Tax deduction and reimbursement tracking applications calculate and store mileage data based on mileage driven by a user and expenses paid for business purposes. The calculated mileage for business purposes may then be used to submit a tax deduction with the Internal Revenue Service (IRS) or for reimbursement reports to an employer. These applications typically track each trip taken by the user and log each of the trips in the application. However, some of the trips logged in the application may not be for a business purpose and may be taken for personal reasons. Therefore, a user of the application may be required to later categorize each of the trips in the log as a business purpose or a personal purpose. Even if the user categorizes the trips on the fly, such as after each trip, this can cause additional steps that must be taken by the user to track and log their trips.

Additionally, these applications may be required to be continuously running on the user's device as a background application to ensure that all the user's trips are tracked and logged. This may cause unnecessary processing by the user's device which can drain the battery power and use an excess amount of memory of the user's device. On the other hand, if the application is not continuously running on the user's device, the user may be required to open the application and initiate the mileage tracker for each trip the user would like to log. This can cause an excessive number of steps for the user. Additionally, requiring the user to initiate tracking each trip may lead a user to accidently miss or incorrectly track trips. Therefore, an improved method of categorizing and selecting tracking mileage and other related expenses for qualifying trips is required.

### Technical Overview

Described herein are systems, methods, and software to provide an expense calculation based on event data. In one implementation, a method of operating a computing system includes receiving one or more events indicating an event type, a location, a date, and a time associated with each of the one or more events. At least one of the events is identified as qualifying for mileage tracking based on the event type associated with the event. A user is determined to be located at the location associated with the qualifying event at the identified date and time associated with the qualifying event. An estimated mileage calculation is then provided based at least in part on the location associated with the qualifying event.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates an operational architecture for implementing an enhanced computing environment to provide an expense calculation based on event data on an electric computing device according to an implementation.

FIG. 2 illustrates a mileage tracking process employed in implementations of an enhanced application to provide an expense calculation based on event data on an electric computing device.

FIG. 3 illustrates an operational architecture to provide an expense calculation based on calendar event data and transportation event data according to an implementation.

FIG. 4 illustrates a sequence diagram to provide an expense calculation based on calendar event data according to an implementation.

FIG. 5 illustrates an alternative sequence diagram to provide an expense calculation based on calendar event data according to an implementation.

FIG. 6 illustrates an exemplary user interface of an application to provide an expense calculation based on calendar event data according to an implementation.

FIG. 7 illustrates an exemplary user interface of an application to provide an expense calculation based on calendar event data according to an implementation.

FIG. 8 illustrates an exemplary user interface of an application to provide an expense calculation based on calendar event data according to an implementation.

FIG. 9 illustrates an exemplary user interface of an application to provide an expense calculation based on calendar event data according to an implementation.

FIG. 10 illustrates an exemplary user interface of an application to provide an expense calculation based on calendar event data according to an implementation.

FIG. 11 illustrates an exemplary user interface of an application to provide an expense calculation based on calendar event data according to an implementation.

FIG. 12 illustrates an exemplary user interface of an application to add a transportation business to a user account in accordance with certain embodiments of the present technology.

FIG. 13 illustrates an exemplary user interface of an application to add a business category to a user account in accordance with certain embodiments of the present technology.

FIG. 14A illustrates an exemplary user interface of an application to automatically synchronize a transportation event in accordance with certain embodiments of the present technology.

FIG. 14B illustrates an exemplary user interface of an application to manually synchronize a transportation event in accordance with certain embodiments of the present technology.

FIG. 15 illustrates an exemplary flow diagram in an implementation to provide an expense calculation based on calendar event data according to an implementation.

FIG. 16 illustrates an exemplary flow diagram in an implementation to provide an expense calculation based on calendar event data according to an implementation.

FIG. 17 illustrates an exemplary flow diagram in an implementation to provide an expense calculation based on calendar event data according to an implementation.

FIG. 18 illustrates a computing system to provide an expense calculation based on event data according to an implementation.

### TECHNICAL DESCRIPTION

Examples of the present disclosure describe an application for providing an expense calculation based on calendar event data. One or more calendar events are received indicating an event type, a location, a date, and a time associated with each of the one or more calendar events. At least one of the one or more calendar events is identified as qualifying for mileage tracking based on the event type associated with the calendar event. A user is determined to be located at the location associated with the qualifying calendar event at the identified date and time associated with the qualifying calendar event. An estimated mileage calculation is then provided based at least in part on the location associated with the qualifying calendar event.

A technical effect that may be appreciated from the present discussion is the increased efficiency in automatically determining which trips qualify as a business purpose without the need for user input or additional processing of tracked trip mileages. Additionally, the user does not need to turn the application on or off or select when to track a trip. In yet a further advantage, the application does not need to be continuously running on the user device to track each trip the user takes.

The application described herein also improves the efficiency in tracking additional data which may be associated with the trip taken for the business purpose, such as automatically tracking other attendees present at the meeting or categorizing associated receipts without requiring the user to manually enter and categorize the information in the application. The location and time that the receipt was acquired may further be used to associate the additional expenses with the categorized calendar event. The location and time may be determined by using natural language detection on a captured receipt or on a received receipt via email, instant messaging, etc. The location and time may be further determined based on a GPS coordinates of the user device at a time in which the receipt was received by the user device. For example, the location of the wireless communication device of a user may be determined upon receiving an email receipt at a time of a qualifying calendar event.

In some embodiments of the present technology, the event to be tracked as a business purpose may be a transportation service associated with a transportation application. One or more businesses associated with a user account may be transportation applications such as Uber or Lyft. A user may associate a transportation business application with the user account to synchronize events that are to be recorded for business purposes.

Further, examples herein described that receiving the one or more calendar events comprises querying a calendar application associated with a user profile and retrieving calendar events stored in the calendar application. In further examples, the times and locations associated with a plurality of qualifying calendar events are tracked in a cloud-based data repository to be ingested by a machine learning system to create at least one additional qualifying calendar event. In this implementation, the user may then be notified that the additional qualifying event was created. The machine learning system may further predict additional calendar event data, such as meeting attendees, a name of the event, the type of business event, and additional expenses. In this scenario, the predicted calendar event data may include a predicted deduction and/or mileage associated with the predicted calendar event.

In some scenarios, identifying the qualifying calendar event comprises identifying a calendar type associated with the calendar event based on at least one of a calendar application type, a calendar type, and a user indication of an event type. In yet another scenario, determining that the user is located at the location associated with the qualifying calendar event at the identified time associated with the qualifying calendar event comprises determining that Global Positioning System (GPS) coordinates of a user device correspond to an address at the date and time associated with the qualifying calendar event.

In other implementations, providing an estimated mileage calculation based at least in part on the location associated with the qualifying calendar event comprises calculating the estimated mileage calculation based on a distance estimation from a default address associated with the user to a meeting address associated with the qualifying calendar event. In yet another implementation, providing an estimated mileage calculation based at least in part on the location associated with the qualifying calendar event comprises calculating the estimated mileage calculation using a current auto mileage calculating algorithm and displaying the estimated mileage calculation on a user interface to an application.

In further examples, providing an estimated mileage calculation based at least in part on the location associated with the qualifying calendar event comprises calculating the estimated mileage calculation using a current auto mileage calculating algorithm and exporting the estimated mileage calculation to an application. In some examples, the qualifying calendar event further indicates names of additional event participants and receipts associated with the calendar event.

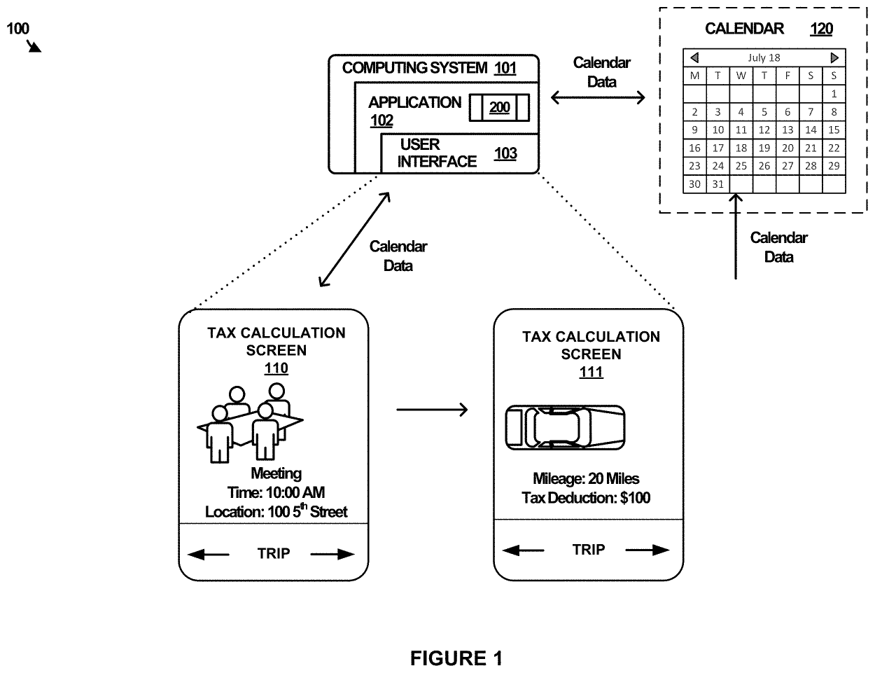

Referring to the drawings. FIG. 1 illustrates an exemplary operational architecture 100 related to processing operations for management of an exemplary enhanced system with which aspects of the present disclosure may be practiced. Operational environment 100 includes computing system 101 comprising application 102. Application 102 employs a mileage tracking process 200. User interface 103 displays the mileage calculation screens 110-111 processed by application 102.

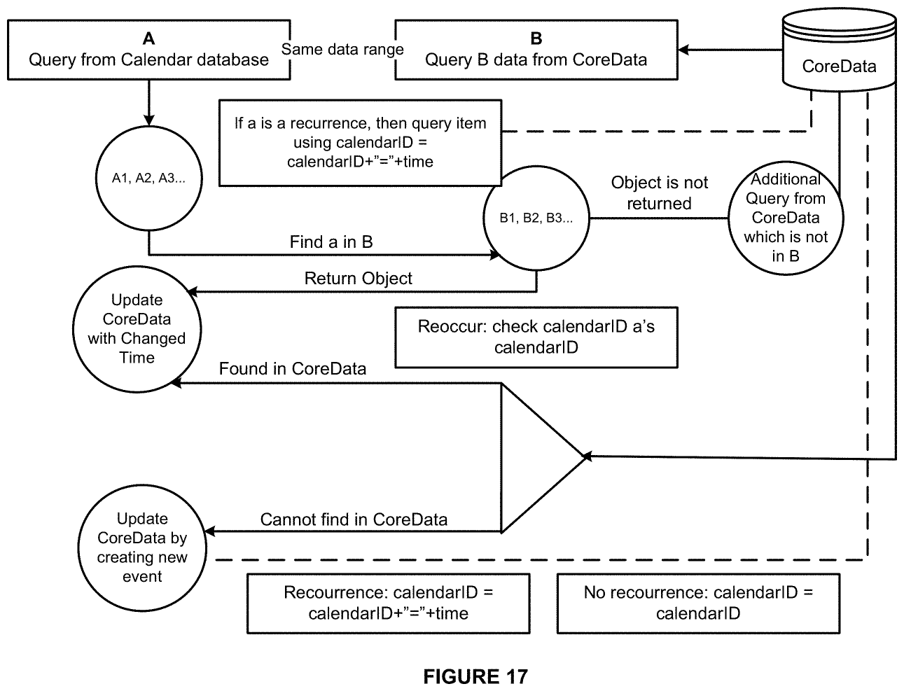

Computing system 101 is representative of any device capable of running an application natively or in the context of a web browser, streaming an application, or executing an application in any other manner. Examples of computing system 101 include, but are not limited to, personal computers, mobile phones, tablet computers, desktop computers, laptop computers, wearable computing devices, or any other form factor, including any combination of computers or variations thereof. Computing system 101 may include various hardware and software elements in a supporting architecture suitable for performing mileage tracking process 200. One such representative architecture is illustrated in FIG. 17 with respect to computing system 1801.

Application 102 includes a software application or application component capable of providing an expense calculation based on calendar event data in accordance with the processes described herein. The software application may be implemented as a natively installed and executed application, a web application hosted in the context of a browser, a streamed or streaming application, a mobile application, or any variation or combination thereof. User interface 103 includes a representative view of mileage tracking screens 110-111 that may be produced by application 102. The user may interface with application 102 over user interface 103 using an input instrument such as a keyboard, stylus, microphone, or any other input device which allows application 102 to receive and process inputted data.

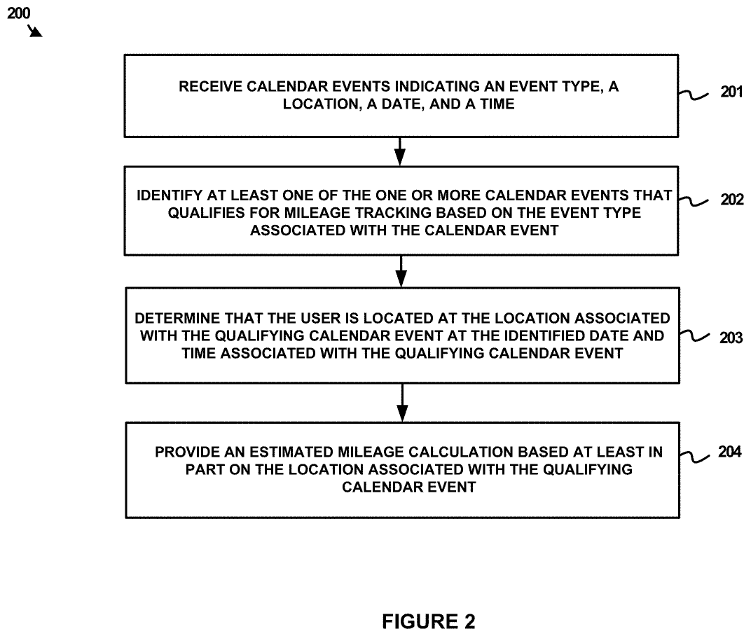

More particularly, FIG. 2 illustrates mileage tracking process 200 which, as mentioned, may be employed by application 102 to identify qualifying calendar events and calculate expenses as described herein. Some or all of the steps of mileage tracking process 200 may be implemented in program instructions in the context of a component or components to the application used to carry out the visual representation display feature. The program instructions direct application 102 to operate as follows, referring parenthetically to the steps in FIG. 2 in the context of FIG. 1.

In operation, application 102 receives one or more calendar events indicating an event type, a location, a date, and a time associated with each of the one or more calendar events (step 201). The calendar event may be entered by the user in an external calendar program, which may be hosted natively on computing system 101, in a cloud-based application, on in combination on a distributed computing system. For example, a user may accept a calendar invite for a business meeting using a web-based calendar service. Application 102 may then extract and synchronize calendar events and related calendar event data entered into the calendar application.

The calendar events each include an event type, such as a business or personal event. In some examples, multiple business types may further be identified. The calendar events each also include a date, a time (and possible duration), and a location of the calendar event. The calendar events may also include a list of attendees, a title indicating the purpose of the meeting, and a recurrent date and time of future meetings.

Application 102 then identifies at least one of the one or more calendar events that qualifies for mileage tracking based on the event type associated with the calendar event (step 202). Application 102 may identify the qualifying calendar events by identifying a calendar type associated with the calendar event based on at least one of a calendar application type, a calendar type, and a user indication of an event type. For example, the event may be entered using a work calendar and therefore, would be allocated as a business event. On the other hand, a calendar event on a personal calendar would not be allocated as a business event. In other scenarios, the event type may be determined based on the location (e.g., office or designated business meeting location), based on additional attendees (e.g., employees and/or clients), or based on a day of the week or time of day (e.g., Monday at 10 AM local time).

In some examples, the user may allocate whether the calendar event qualifies as a business event or a personal event. For example, the user may color or flag business meetings in a calendar to indicate that the calendar event is a business event. In yet a further example, application 102 may determine the event type using machine learning algorithms which may automatically categorize the calendar events based on the title of the calendar event, the date and time of the calendar events, the list of attendees for the calendar event, the location of the calendar event, and the like.

In yet another example, application 102 may create a reoccurring qualifying calendar event based on the date and time of the calendar events. In this example scenario, the user may then be notified that the additional calendar event was created and that the type of the calendar event was set by application 102. For example, a meeting occurring each first Monday of the month at a designated time may be predicted using the machine learning system. The machine learning system may further predict additional calendar event data, such as meeting attendees, a name of the event, the type of business event, and additional expenses. In this scenario, the predicted calendar event data may include a predicted deduction associated with the predicted calendar event. For example, the machine learning system may predict a mileage amount, a number and name of additional attendees, and additional expenses which will likely be incurred and are associated with the business calendar event.

In a next operation, application 102 determines that the user is located at the location associated with the qualifying calendar event at the identified date and time associated with the qualifying calendar event (step 203). For example, application 102 may not always track the mileage or calculate mileage until a date and time in which a qualifying calendar event is scheduled to occur. At this date and time, application 102 may determine whether the user (or user device) is located at the location specified in the calendar event. For example, if the user device indicates that it is located at the address and/or meeting room at the date and time of the meeting, application 102 may determine that the user has attended the meeting and therefore, the mileage information should be tracked. On the other hand, if the user device is not located at the location of the meeting at the specified date and time indicated in the calendar event, application 102 may assume that the user did not attend the meeting and the no mileage calculation should be performed.

In some scenarios, the user location is determined by determining that Global Positioning System (GPS) coordinates of a user device correspond to an address at the date and time associated with the qualifying calendar event. The GPS coordinates may be of a user's mobile phone, a user's smart watch, a user's computer, or any other indication that the user is located at the location of the meeting. However, the user location may also be determined using other techniques, such as determining that a user has checked in at the location's concierge, determining that the user has logged onto an on-site computer using personal login information, receiving an alert that the user has scanned a parking pass or access pass, or receiving a notification from the organizer of the calendar meeting that the user of application 102 is present at the meeting.

In a final operation, application 102 provides an estimated mileage calculation based at least in part on the location associated with the qualifying calendar event (step 204). The estimated mileage calculation may be calculated based on a distance estimation from a default address associated with the user to an address associated with the qualifying calendar event. The default address may be a user's home address, a user's office address, a previous meeting location address, a hotel address, or any other address which may be designated by the user for calculating mileage.

It should be noted that application 102 may further calculate additional expense information. The user of application 102 may be prompted to enter additional data to perform the calculation, such as by prompting the user to insert a receipt that is associated with the qualifying calendar event. In other scenarios, application 102 may query the user's bank statements, email, text messages, and the like to retrieve receipts which are associated with the qualifying calendar event. The additional data may then be used to calculate additional expense amounts associated with the calculated mileage.

In some examples, application 102 may provide the estimated mileage calculation by using a current auto mileage calculating algorithm and displaying the estimated mileage calculation on user interface 103 to application 102. It should be understood that application 102 may also provide the estimated mileage calculation by exporting the estimated mileage calculation to another application. For example, a mileage tracking report may be generated by application 102 and exported into a standardized form used for reimbursements in an additional application. In other examples, the mileage report may be generated by a third-party transportation application and synchronized with the present expense tracking application. In yet another example, the mileage tracking report may be used to calculate a tax deduction and/or reimbursement which may be automatically submitted to a third-party entity. In another example, the report may be emailed or otherwise messaged to the user or a third-party entity.

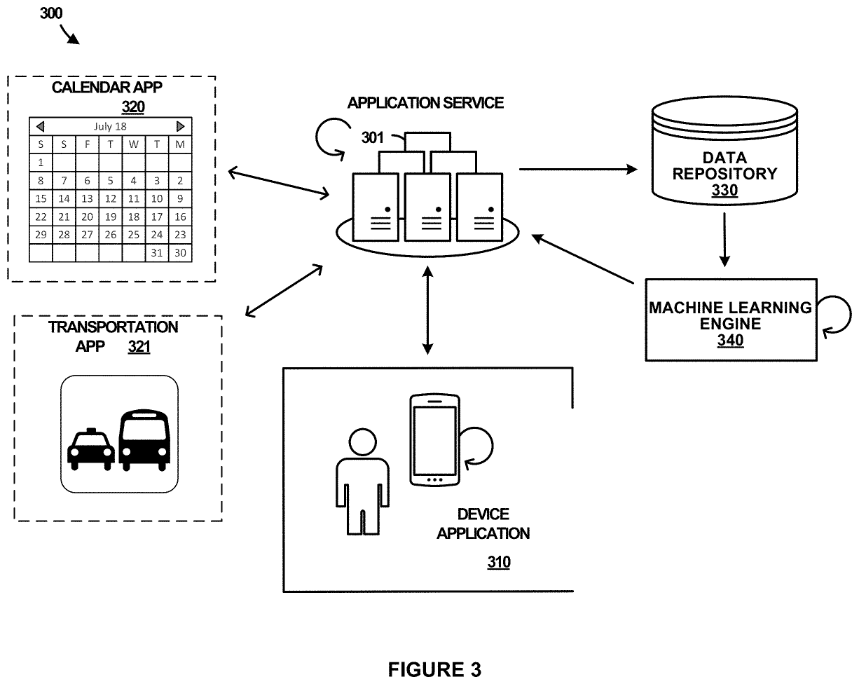

FIG. 3 illustrates an operational architecture to provide an expense calculation based on calendar event data according to an implementation. Operational environment 300 includes application service 301, device application 310, calendar application 320, transportation application 321, data repository 330, and machine learning engine 340. It should be understood that application service 301 and device application 310 comprise an expense tracking application in which steps in the process of providing the expense calculation may be performed, in part or in whole, by each of application service 301 and device application 310. Calendar application 320 and/or transportation application 321 receives user input which includes events indicating an event type, date, time, location, and any other event related data, such as a list of attendees/riders/drivers.

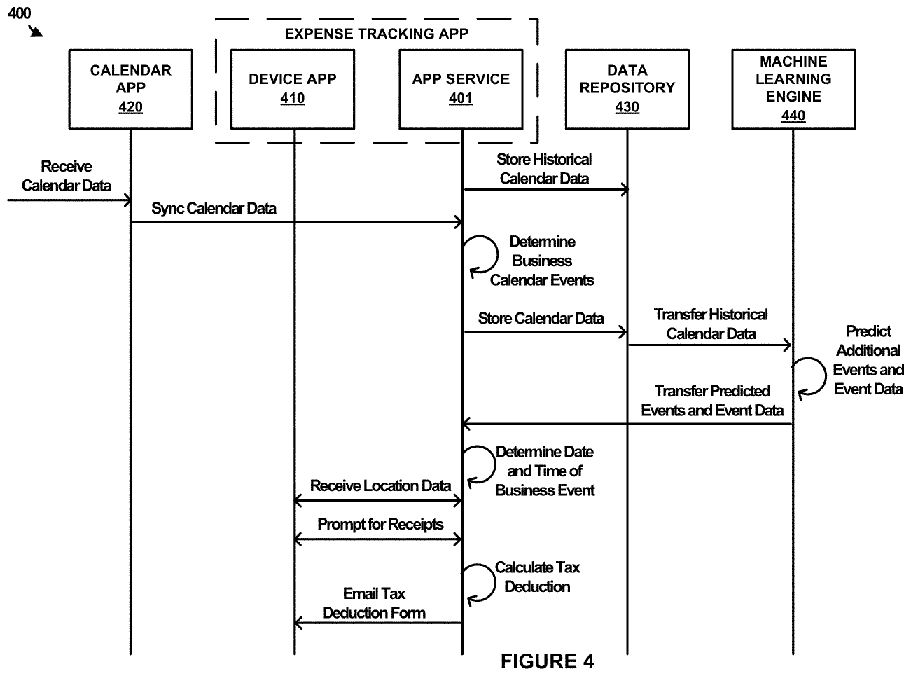

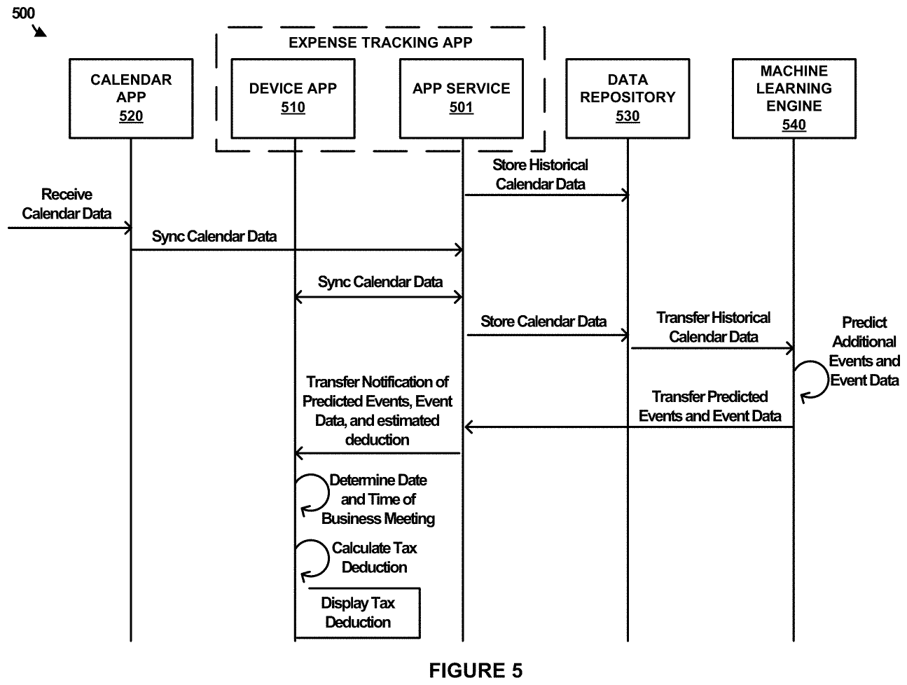

Data repository 330 is a cloud-based data repository which stores historical calendar and transportation data which may be transferred to machine learning engine 340 for processing. Machine learning engine 340 predicts additional calendar and transportation events and associated calendar and transportation event data, such as a date, a time, locations, additional attendees, and predicted associated expenses, such as meal, gas, and parking costs. Device application 310 may synchronize the synced calendar and transportation data and the predicted calendar and transportation event data, or transfer location information to application service 301. Two sample operational scenarios of operational environment 300 are illustrated below in FIG. 4 and FIG. 5.

FIG. 4 illustrates a sequence diagram to provide an expense calculation based on calendar event data according to an implementation from operational environment 400. In operation, application service 401 stores all historical calendar data in data repository 430. In a next operation, calendar application 420 receives user input indicating upcoming calendar data. Calendar application 420 then synchronizes the upcoming calendar data with application service 301 which in turn, determines which events comprise business calendar events. Application service 301 also stores the upcoming calendar data in data repository 430.

Next, machine learning engine 440 receives the historical calendar data from data repository 430 and predicts additional events and their associated event data. For example, the associated event data may include a predicted location, time, date, list of attendees, and additional expenses (e.g., meal receipts). These predicted events and their associated event data are then transferred to application service 401. At this point, application service 401 determines that it is the date and time of one of the business calendar events. Application 401 then queries device application 410 for a current location of the user device. Application 401 also prompts the user over device application 410 to enter additional expense information, such as for additional receipts. Based on the location of the user and the additional expense information, application service 401 calculates a tax deduction amount. In a final operation, application service 401 emails the tax deduction form to the user in device application 410.

FIG. 5 illustrates an alternative sequence diagram to provide an expense calculation based on calendar event data according to an implementation from operational environment 500. In operation, application service 501 stores all historical calendar data in data repository 530. In a next operation, calendar application 520 receives user input indicating upcoming calendar data. Calendar application 520 then synchronizes the upcoming calendar data with device application 510 over application service 501. Application service 501 also stores the upcoming calendar data in data repository 530.

Next, machine learning engine 540 receives the historical calendar data from data repository 530 and predicts additional events and associated event data. The event data may include a predicted meeting location, date, time, list of attendees, and additional expenses (e.g., receipts for parking). These predicted events and their associated event data are then transferred to application service 501. At this point, application service 501 transfers a notification to device application 510 that the predicted events have been created and what the estimated deduction will be. Device application 510 then determines that it is the date and time for a meeting and calculates a tax deduction based on its location at the date and time of the calendar event. In a final operation, device application 510 displays the tax deduction form to the user.

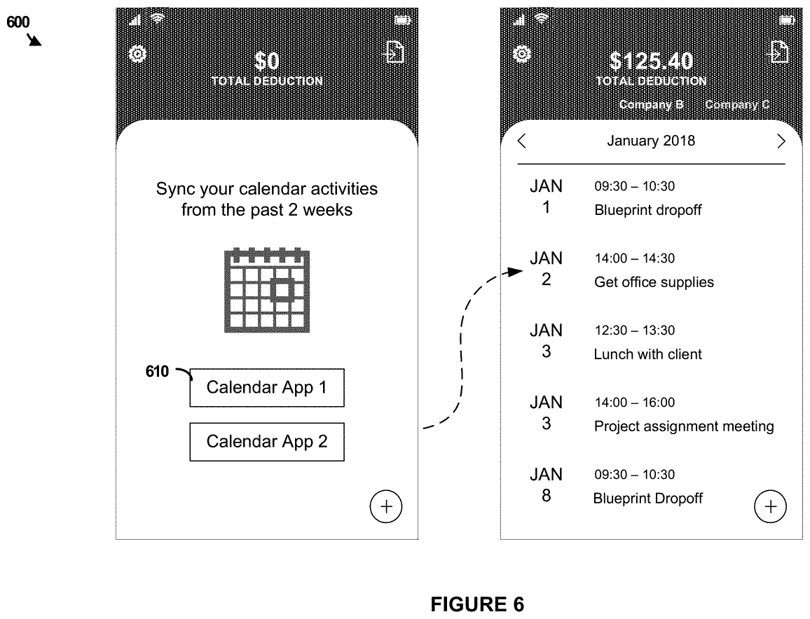

FIG. 6 illustrates an exemplary user interface 600 of an application to provide an expense calculation based on calendar event data according to an implementation. In particular, FIG. 6 illustrates how a calendar application 610 may automatically sync with the mileage tracking application. Advantageously, the user is not required to manually enter, categorize, or log each event. Furthermore, the mileage tracking application may automatically update the calendar in the mileage tracking application when events are moved, deleted, or added. In addition, the mileage tracking application may automatically sync with another type of application including a transportation application. Examples of transportation applications include Uber, Lyft, and any other third-party transportation applications allowing a user to conduct a transportation business. Business activities recorded on a transportation application may be used to automatically or manually update the mileage tracking application.

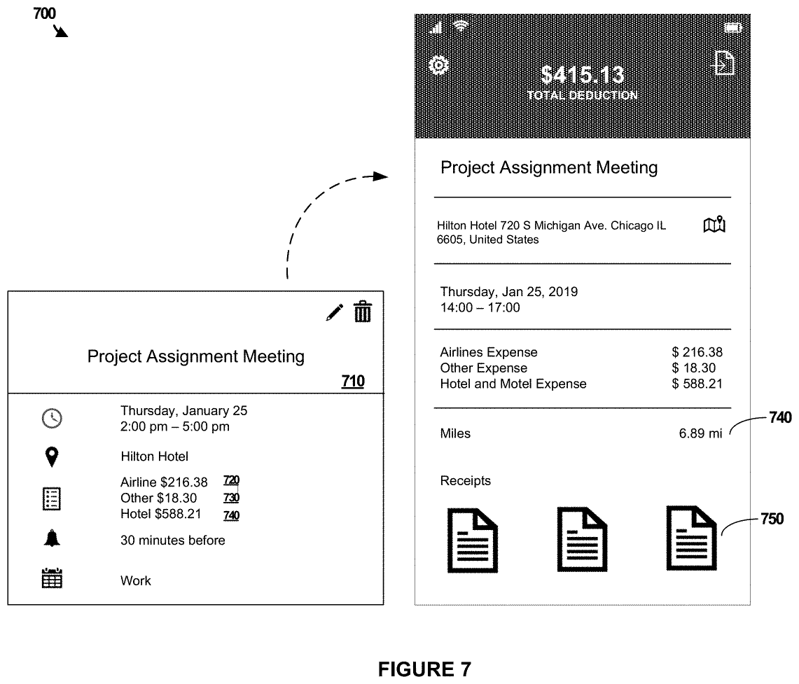

FIG. 7 illustrates an exemplary user interface 700 of an application to provide an expense calculation based on calendar event data according to an implementation. In particular, FIG. 7 illustrates how the mileage tracking application tracks all qualified calendar events. Advantageously, even if a user forgets to log an event, the mileage tracking application automatically tracks the occurrence of the event and any related information, such as the duration, related receipts and other expenses, and attendees. These additional logged expenses may be grouped with the calendar event 710, such as airline tickets 720, hotel expenses 730, and all mileage calculations performed within a period of time. For example, the mileage tracking application may track all mileage logs 740 and receipts 750 in the same report.

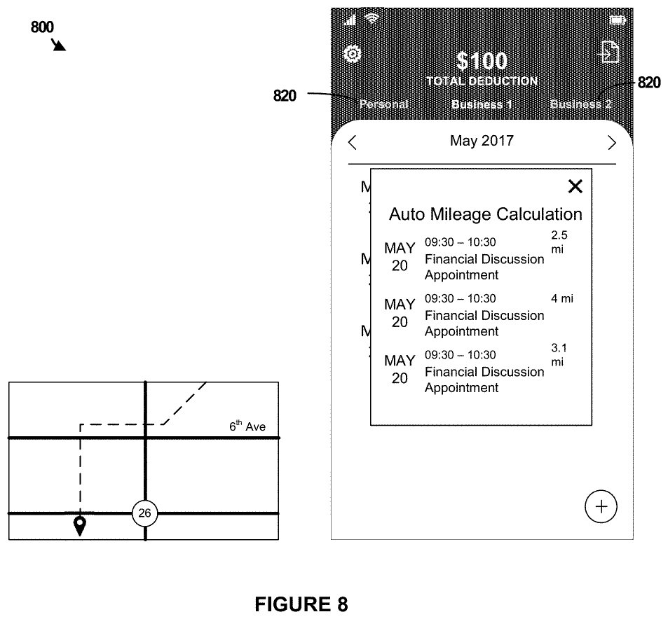

FIG. 8 illustrates an exemplary user interface 800 of an application to provide an expense calculation based on calendar event data according to an implementation. In particular, FIG. 8 illustrates how the mileage tracking application may remember and differentiate between personal 810 and business-related 820 drives. Advantageously, the user is not required to indicate the category for the log repeatedly.

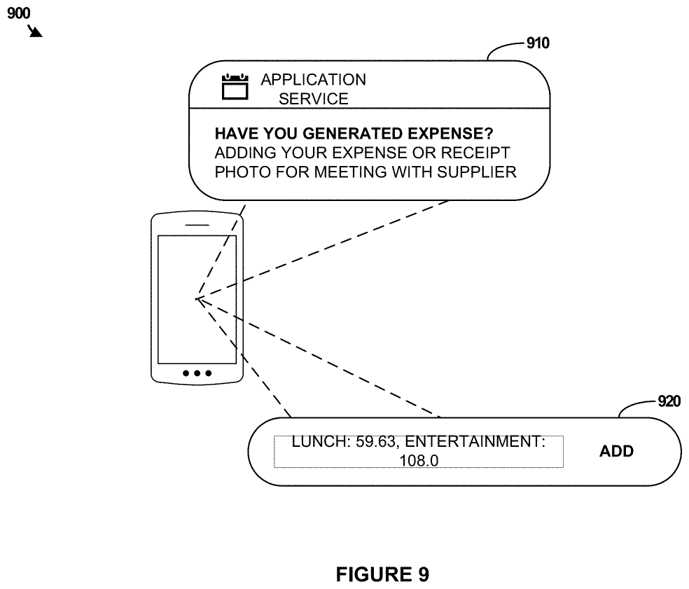

FIG. 9 illustrates an exemplary user interface 900 of an application to provide an expense calculation based on calendar event data according to an implementation. In particular, FIG. 9 illustrates how smart notifications 910 may be prompted to allow a user to make adjustments to the logs or add additional information 920 associated with the log (such as receipts or other notes) on the fly. Advantageously, this allows the user to implement changes to the mileage calculation and other business-related information before the user forgets.

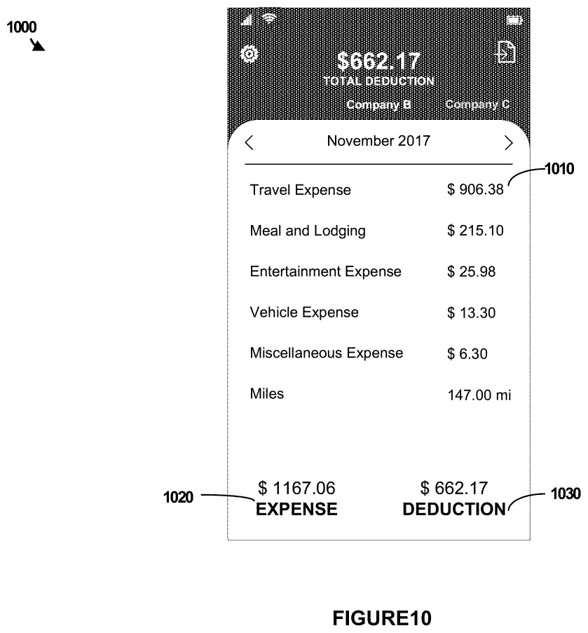

FIG. 10 illustrates an exemplary user interface 1000 of an application to provide an expense calculation based on calendar event data 1010 according to an implementation. In particular, FIG. 10 illustrates how expenses 1020 may be calculated along with deductions 1030. Advantageously, this allows the user to see at a glance how much was spent and saved by the user for each calendar event.

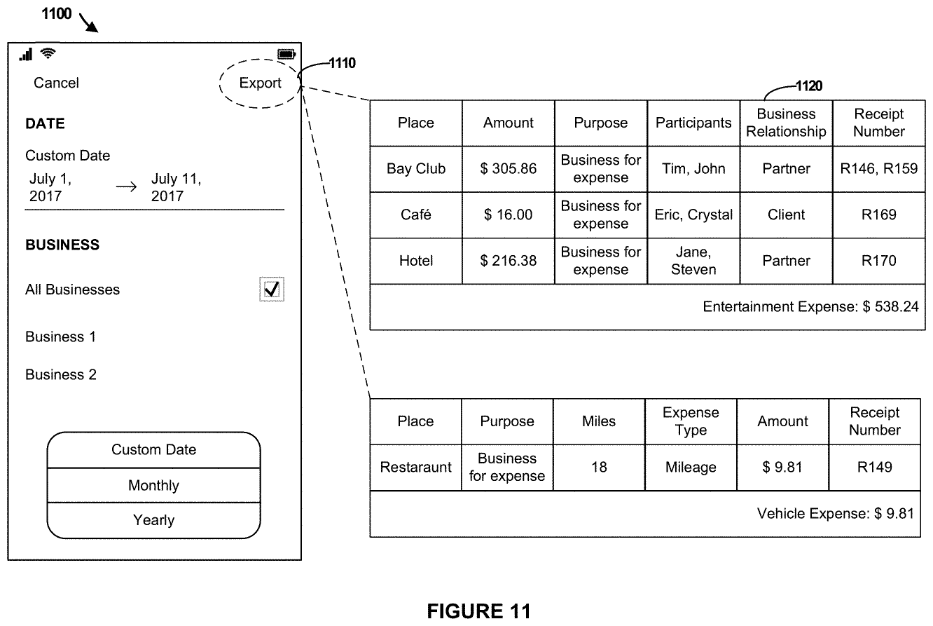

FIG. 11 illustrates an exemplary user interface 1100 of an application to provide an expense calculation based on calendar event data according to an implementation. In particular, FIG. 11 illustrates how the user may choose any export 1110 format the user desires. The exportation formats may be generated by the mileage tracking application to accommodate for the most popular or relevant forms 1120, such as IRS deduction forms or reimbursement forms. However, the user may further customize or create forms or export formats which can be used for tax reductions and accounting purposes.

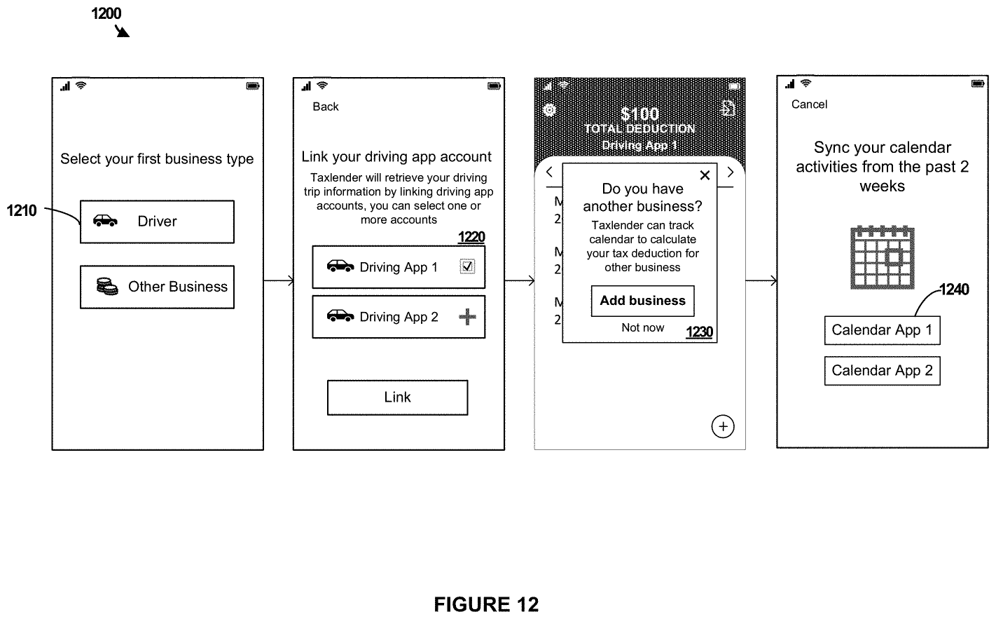

FIG. 12 illustrates an exemplary user interface of an application to provide an expense calculation based on a linked transportation account. In accordance with certain embodiments of the present technology, a user may be prompted to select a business type 1210 for their account and link a transportation application 1220. Examples of transportation applications 1220 include Uber, Lyft, and any other third-party transportation applications enabling a user to conduct a transportation business. The user may add additional businesses 1230 to the account after adding a transportation business. Upon adding a transportation business, the user may be prompted to add an optional additional business, which may be synced through calendar applications 1240.

For example, the driver or rider using the transportation application 1210 may track a trip in the transportation application 1210. The trip information may then be received in the device application which indicates the event type, a location, a date, and a time associated with each of the transportation events. The device application may also identify whether the transportation event qualifies for mileage tracking based on the event type associated with the calendar event. The application may then extract the location information (i.e., pick-up and drop-off locations) from the trip and associate the location (and time) with the transportation event. Based on the location information extracted from the transportation application, the device application may then provide an estimated mileage calculation based at least in part on the location associated with the qualifying location event.

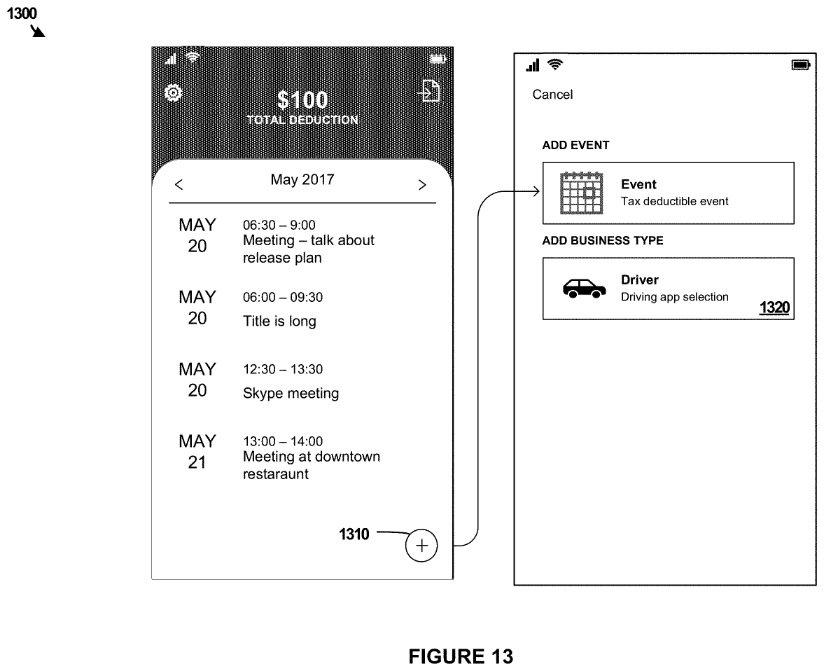

FIG. 13 illustrates an exemplary user interface 1300 of an application to provide an expense calculation based on a linked transportation account. In particular, FIG. 13 shows an example user interface previously linked to a business. A user may add an additional business type with an “add” 1310 feature within the user interface. The user may be prompted to select the type of business to add, wherein the user may optionally select a transportation business through a transportation application 1320.

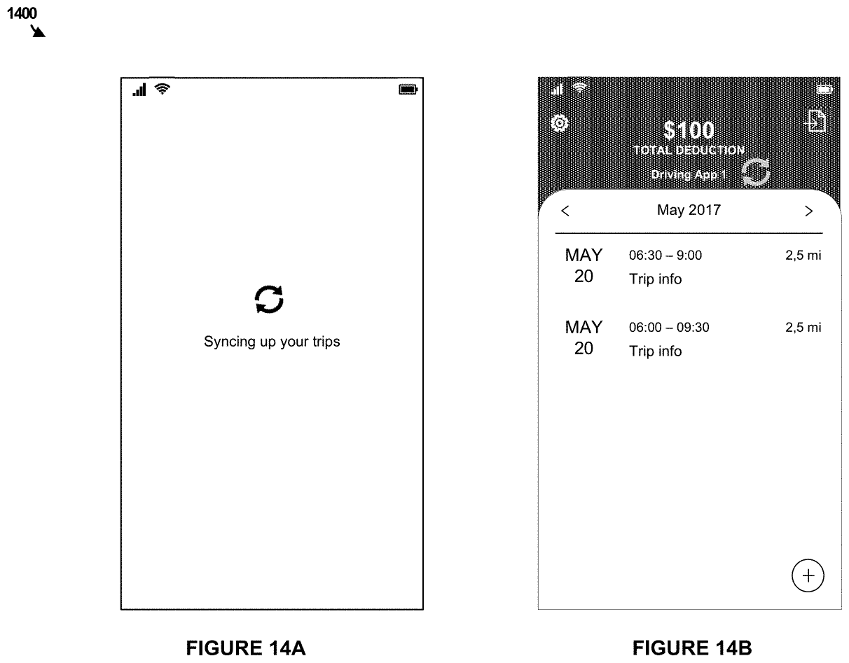

FIGS. 14A and 14B illustrate an exemplary user interface 1400 of an application to provide an expense calculation based on a linked transportation account. In particular, FIG. 14A demonstrates a user interface to automatically synchronize trips associated with a transportation business through a transportation application after at least 24 hours of an event on the transportation application. FIG. 14B demonstrates a user interface to manually update the application with trips associated with a transportation business within 24 hours of an event on the transportation application. Examples of transportation applications include Uber, Lyft, and any other third-party transportation applications enabling a user to conduct a transportation business.

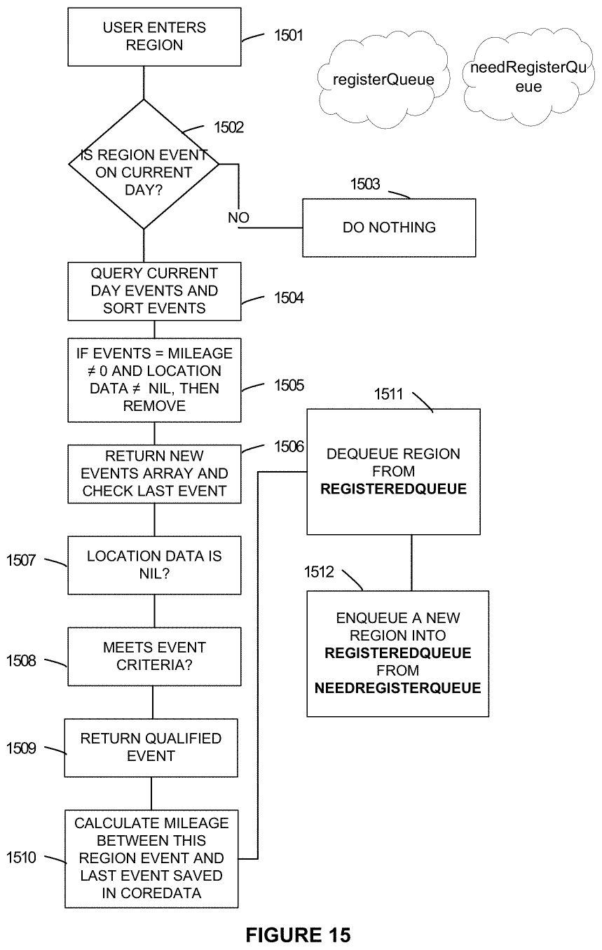

FIG. 15 illustrates an exemplary flow diagram in an implementation to provide an expense calculation based on calendar event data according to an implementation. In a first operation, the user enters a region which is detected by the application using the location tracking settings (step 1501). The application then determines whether the region is associated with an event on the current day (step 1502). If the region is not associated with an event on the current day, then the application does not track the trip (step 1503). However, if the region is associated with an event on the current day, then the application queries the current day events and sorts the events (step 1504). Events that do not have a mileage equaling zero and where there is associated location are then removed (step 1505). A new events array is then returned, and the last event is checked (step 1506). At this point, the location data is determined (step 1507) and it is determined that the event meets the criteria (step 1508). As a result, the qualified event is returned (step 1509). The mileage between the region event and the last event is saved in the core data is then calculated (step 1513). The region is then dequeued from the registeredQueue (step 1514) and a new region is queued into the registeredQueue from the needRegisterQueue (step 1515).

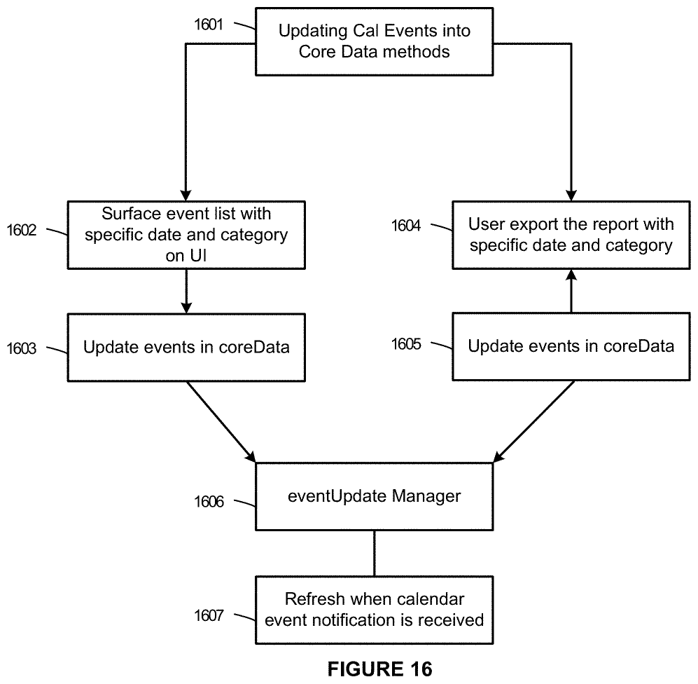

FIG. 16 illustrates an exemplary flow diagram in an implementation to provide an expense calculation based on calendar event data according to an implementation. In particular, FIG. 16 illustrates how calendar data may be updated and synchronized between a calendar application and an expense tracking application. In operation, the updating of the Calendar Events into Core Data methods is initiated (step 1601). In a next operation, an events list is surfaced with a specific date and a category on the user interface (step 1602). Next, the events in the coreData is updated (step 1603). In a parallel operation, a user may export a report with one or more specific dates and categories (step 1604). This may also trigger the events in the coreData to be updated (step 1605). The updates are then communicated to an eventUpdate Manager (step 1606) and refreshed when a calendar event notification is received (step 1607).

FIG. 17 illustrates an exemplary flow diagram in an implementation to provide an expense calculation based on calendar event data according to an implementation. In particular, FIG. 17 illustrates how calendar data may be updated and synchronized between a calendar application and an expense tracking application. As illustrated in FIG. 17, data may be queried from CoreData and a Calendar database. For example, data A is queried from the Calendar database and data B is queried from CoreData. It is then queried whether the event “a” can be found in dataset B. If an object is returned, then CoreData is updated. If an object is not returned, an additional query is performed from CoreData without data B. If the event is found in the CoreData using the additional query, a time has been changed for a and CoreData is updated with the new time. If event “a” cannot be found, then CoreData is updated with the information and a new event is created in CoreData. It should also be noted that if event “a” is a recurring event, then event “a” by be queried in CoreData using a calendar ID. The calendar ID may be set using the calendar ID plus the reoccurrence time, such as the number of the occasions that the event has occurred. Furthermore, if the calendar ID is not a reoccurrence, then the calendar ID will be set to its original name (e.g., calendar ID).

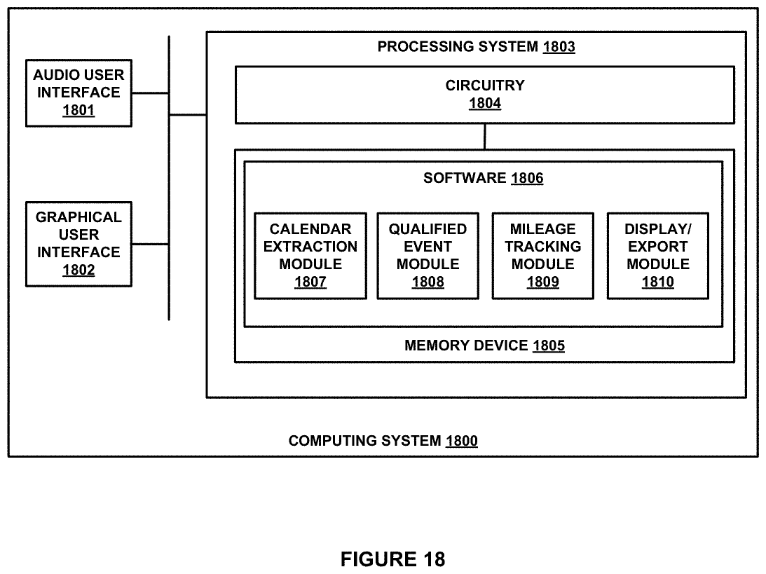

Referring now to FIG. 18, a block diagram that illustrates computing system 1800 in an exemplary implementation is shown. Computing system 1800 provides an example of computing system 101 or any computing system that may be used to function as shown and described herein, although such systems could use alternative configurations. Computing system 1800 comprises audio user interface 1801, graphical user interface 1802, and processing system 1803. Processing system 1803 is linked to audio user interface 1801 and graphical user interface 1802. Processing system 1803 includes processing circuitry 1804 and memory device 1805 that stores operating software 1806. Computing system 1800 may include other well-known components such as a battery and enclosure that are not shown for clarity.

Computing system 1800 may be representative of any computing apparatus, system, or systems on which an application or variations thereof may be suitably implemented. Computing system 1800 may reside in a single device or may be distributed across multiple devices. Examples of computing system 1800 include mobile computing devices, such as cell phones, tablet computers, laptop computers, notebook computers, and gaming devices, as well as any other type of mobile computing devices and any combination or variation thereof. Note that the features and functionality of computing system 1800 may apply as well to desktop computers, server computers, and virtual machines, as well as any other type of computing system, variation, or combination thereof.

Referring still to FIG. 18, processing system 1803 is operatively coupled with memory device 1805, audio user interface 1801, and graphical user interface 1802. Processing system 1803 loads and executes software 1806 from memory device 1805. Processing system 1803 may comprise a microprocessor and other circuitry that retrieves and executes software 1806 from memory device 1805. Processing system 1803 may be implemented within a single processing device but may also be distributed across multiple processing devices or sub-systems that cooperate in executing program instructions. Examples of processing system 1803 include general purpose central processing units, application specific processors, and logic devices, as well as any other type of processing device, combinations, or variations thereof.

Memory device 1805 may comprise any computer readable media or storage media readable by processing system 1803 and capable of storing software 1806. Memory device 1805 may include volatile and nonvolatile, removable and non-removable media implemented in any method or technology for storage of information, such as computer readable instructions, data structures, program modules, or other data. Memory device 1805 may be implemented as a single storage device but may also be implemented across multiple storage devices or sub-systems co-located or distributed relative to each other. Memory device 1805 may comprise additional elements, such as a controller, capable of communicating with processing system 1803. Examples of storage media include random-access memory, read-only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the storage media a propagated signal.

In operation, processing system 1803 loads and executes portions of software 1806, such as application modules 1807-1810, to operate as described herein or variations thereof. Software 1806 may be implemented in program instructions and among other functions may, when executed by computing system 1800 in general or processing system 1803 in particular, direct computing system 1800 or processing system 1803 to operate as described herein or variations thereof. Software 1806 may include additional processes, programs, or components, such as operating system software or other application software. Software 1806 may also comprise firmware or some other form of machine-readable processing instructions executable by processing system 1803.

In general, software 1806 may, when loaded into processing system 1803 and executed, transform computing system 1800 overall from a general-purpose computing system into a special-purpose computing system customized operate as described herein for each implementation or variations thereof. For example, encoding software 1806 on memory device 1805 may transform the physical structure of memory device 1805. The specific transformation of the physical structure may depend on various factors in different implementations of this description. Examples of such factors may include, but are not limited to, the technology used to implement the storage media of memory device 1805 and whether the computer-readable storage media are characterized as primary or secondary storage.

In some examples, if the computer-readable storage media are implemented as semiconductor-based memory, software 1806 may transform the physical state of the semiconductor memory when the program is encoded therein. For example, software 1806 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 1800 is generally intended to represent a computing system with which software 1806 is deployed and executed in order to implement application modules 1807-1810 to operate as described herein for each implementation (and variations thereof). However, computing system 1800 may also represent any computing system on which software 1806 may be staged and from where software 1806 may be distributed, transported, downloaded, or otherwise provided to yet another computing system for deployment and execution, or yet additional distribution. For example, computing system 1800 could be configured to deploy software 1806 over the internet to one or more client computing systems for execution thereon, such as in a cloud-based deployment scenario.

Audio user interface 1801 and graphical user interface 1802 may include a voice input device, a touch input device for receiving a gesture from a user, a motion input device for detecting non-touch gestures and other motions by a user, and other comparable input devices and associated processing elements capable of receiving user input from a user. Output devices such as a display, speakers, haptic devices, and other types of output devices may also be included in audio user interface 1801 and graphical user interface 1802. In some examples, graphical user interface 1802 could include a touch screen capable of displaying a graphical user interface that also accepts user inputs via touches on its surface. The aforementioned user input devices are well known in the art and need not be discussed at length here. Audio user interface 1801 and graphical user interface 1802 may also each include associated user interface software executable by processing system 1803 in support of the various user input and output devices discussed above. Separately or in conjunction with each other and other hardware and software elements, the user interface software and devices may provide a graphical user interface, a natural user interface, or any other kind of user interface.

Although not shown, computing system 1800 may also include a communication interface and other communication connections and devices that allow for communication between computing system 1800 and other computing systems (not shown) or services. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

### Example 1

A computing apparatus comprising: one or more computer readable storage media; one or more processors operatively coupled with the one or more computer readable storage media; and program instructions stored on the one or more computer readable storage media that, when read and executed by the one or more processors, direct the one or more processors to at least: receive one or more calendar events indicating an event type, a location, a date, and a time associated with each of the one or more calendar events; identify at least one of the one or more calendar events that qualifies for mileage tracking based on the event type associated with the calendar event; determine that the user is located at the location associated with the qualifying calendar event at the identified date and time associated with the qualifying calendar event; and provide an estimated mileage calculation based at least in part on the location associated with the qualifying calendar event.

### Example 2

The computing apparatus of Example 1 wherein to receive the one or more calendar events, the program instructions direct the one or more processors to query a calendar application associated with a user profile and retrieve calendar events stored in the calendar application.

### Example 3

The computing apparatus of Examples 1-2 wherein the program instructions further direct the one or more processors to track the times and locations associated with a plurality of qualifying calendar events in a cloud-based data repository to be ingested by a machine learning system to create at least one additional qualifying calendar event having associated calendar event data.

### Example 4

The computing apparatus of Examples 1-3 wherein the program instructions further direct the one or more processors to notify the user that the additional qualifying event having the associated calendar event data was created.

### Example 5

The computing apparatus of Examples 1-4 wherein to identify the qualifying calendar event, the program instructions direct the one or more processors to identify a calendar type associated with the calendar event based on at least one of a calendar application type, a calendar type, and a user indication of an event type.

### Example 6

The computing apparatus of Examples 1-5 wherein to determine that the user is located at the location associated with the qualifying calendar event at the identified time associated with the qualifying calendar event, the program instructions direct the one or more processors to determine that Global Positioning System (GPS) coordinates of a user device correspond to an address at the date and time associated with the qualifying calendar event.

### Example 7

The computing apparatus of Examples 1-8 wherein to provide an estimated mileage calculation based at least in part on the location associated with the qualifying calendar event, the program instructions direct the one or more processors to calculate the estimated mileage calculation based on a distance estimation from a default address associated with the user to an address associated with the qualifying calendar event.

### Example 8

The computing apparatus of Examples 1-9 wherein to provide an estimated mileage calculation based at least in part on the location associated with the qualifying calendar event, the program instructions direct the one or more processors to calculate the estimated mileage calculation using a current auto mileage calculating algorithm and display the estimated mileage calculation on a user interface to an application.

### Example 9

The computing apparatus of Examples 1-8 wherein to provide an estimated mileage calculation based at least in part on the location associated with the qualifying calendar event, the program instructions direct the one or more processors to calculate the estimated mileage calculation using a current auto mileage calculating algorithm and export the estimated mileage calculation to an application.

### Example 10

The computing apparatus of Examples 1-9 wherein the qualifying calendar event further indicates names of additional event participants and receipts associated with the calendar event.

### Example 11

A method comprising: receiving one or more calendar events indicating an event type, a location, a date, and a time associated with each of the one or more calendar events; identifying at least one of the one or more calendar events that qualifies for mileage tracking based on the event type associated with the calendar event; determining that the user is located at the location associated with the qualifying calendar event at the identified date and time associated with the qualifying calendar event; and providing an estimated mileage calculation based at least in part on the location associated with the qualifying calendar event.

### Example 12

The method of Example 11 wherein receiving the one or more calendar events comprises querying a calendar application associated with a user profile and retrieve calendar events stored in the calendar application.

### Example 13

The method of c Examples 11-12 further comprising tracking the times and locations associated with a plurality of qualifying calendar events in a cloud-based data repository to be ingested by a machine learning system to create at least one additional qualifying calendar event having associated calendar event data.

### Example 14

The method of Examples 11-13 further comprising notifying the user that the additional qualifying event having the associated calendar event data was created.

### Example 15

The method of Examples 11-14 wherein identifying the qualifying calendar event comprises identifying a calendar type associated with the calendar event based on at least one of a calendar application type, a calendar type, and a user indication of an event type.

### Example 16

The method of Examples 11-15 wherein determining that the user is located at the location associated with the qualifying calendar event at the identified time associated with the qualifying calendar event comprises determining that Global Positioning System (GPS) coordinates of a user device correspond to an address at the date and time associated with the qualifying calendar event.

### Example 17

The method of Examples 11-16 wherein providing an estimated mileage calculation based at least in part on the location associated with the qualifying calendar event comprises calculating the estimated mileage calculation based on a distance estimation from a default address associated with the user to an address associated with the qualifying calendar event.

### Example 18

The method of Examples 11-17 wherein providing an estimated mileage calculation based at least in part on the location associated with the qualifying calendar event comprises calculating the estimated mileage calculation using a current auto mileage calculating algorithm and displaying the estimated mileage calculation on a user interface to an application.

### Example 19

The method of Examples 11-18 wherein providing an estimated mileage calculation based at least in part on the location associated with the qualifying calendar event comprises calculating the estimated mileage calculation using a current auto mileage calculating algorithm and exporting the estimated mileage calculation to an application.

### Example 20

The method of Examples 11-29 wherein the qualifying calendar event further indicates names of additional event participants and receipts associated with the calendar event.

### Example 21

A computing apparatus comprising: one or more computer readable storage media; one or more processors operatively coupled with the one or more computer readable storage media; and program instructions stored on the one or more computer readable storage media that, when read and executed by the one or more processors, direct the one or more processors to at least: receive one or more events indicating an event type, locations, a date, and a time associated with each of the one or more events; identify at least one of the one or more events that qualify for mileage tracking based on the event type associated with the event; and provide an estimated mileage calculation based at least in part on the locations associated with the qualifying event.

### Example 22

The computing apparatus of Example 21, wherein the one or more events comprise a transportation event and wherein the locations associated with the qualifying event comprises at least one of a pick-up location and a drop-off location of a trip.

### Example 23

The computing apparatus of Examples 21-22, wherein event type, locations, date, and time associated with each of the one or more events are automatically received from a transportation application.

### Example 24

The computing apparatus of Examples 21-23, wherein the estimated mileage calculation is provided to a driver of a transportation application based at least in part on the locations associated with the qualifying event.

### Example 25

The computing apparatus of Examples 21-24, wherein the estimated mileage calculation is provided to a rider of a transportation application based at least in part on the locations associated with the qualifying event.

### Example 26

The computing apparatus of Examples 21-25 wherein the qualifying event further indicates names of additional transportation event riders and receipts associated with the event.

What is claimed is:

1. A computing apparatus comprising:
one or more computer readable storage media;
one or more processors operatively coupled with the one or more computer readable storage media; and
program instructions stored on the one or more computer readable storage media that, when read and executed by the one or more processors, direct the one or more processors to at least:
receive one or more calendar events indicating an event type, a location, a date, and a time associated with each of the one or more calendar events;
identify at least one of the one or more calendar events that qualifies for mileage tracking based on the event type associated with the calendar event;
determine that the user is located at the location associated with the qualifying calendar event at the identified date and time associated with the qualifying calendar event; and
provide an estimated mileage calculation based at least in part on the location associated with the qualifying calendar event.

2. The computing apparatus of claim 1 wherein to receive the one or more calendar events, the program instructions direct the one or more processors to query a calendar application associated with a user profile and retrieve calendar events stored in the calendar application.

3. The computing apparatus of claim 1 wherein the program instructions further direct the one or more processors to track the times and locations associated with a plurality of qualifying calendar events in a cloud-based data repository to be ingested by a machine learning system to create at least one additional qualifying calendar event having associated calendar event data.

4. The computing apparatus of claim 3 wherein the program instructions further direct the one or more processors to notify the user that the additional qualifying event having the associated calendar event data was created.

5. The computing apparatus of claim 1 wherein to identify the qualifying calendar event, the program instructions direct the one or more processors to identify a calendar type associated with the calendar event based on at least one of a calendar application type, a calendar type, and a user indication of an event type.

6. The computing apparatus of claim 1 wherein to determine that the user is located at the location associated with the qualifying calendar event at the identified time associated with the qualifying calendar event, the program instructions direct the one or more processors to determine that Global Positioning System (GPS) coordinates of a user device correspond to an address at the date and time associated with the qualifying calendar event.

7. The computing apparatus of claim 1 wherein to provide an estimated mileage calculation based at least in part on the location associated with the qualifying calendar event, the program instructions direct the one or more processors to calculate the estimated mileage calculation based on a distance estimation from a default address associated with the user to an address associated with the qualifying calendar event.

8. The computing apparatus of claim 1 wherein to provide an estimated mileage calculation based at least in part on the location associated with the qualifying calendar event, the program instructions direct the one or more processors to calculate the estimated mileage calculation using a current auto mileage calculating algorithm and display the estimated mileage calculation on a user interface to an application.

9. The computing apparatus of claim 1 wherein to provide an estimated mileage calculation based at least in part on the location associated with the qualifying calendar event, the program instructions direct the one or more processors to calculate the estimated mileage calculation using a current auto mileage calculating algorithm and export the estimated mileage calculation to an application.

10. The computing apparatus of claim 1 wherein the qualifying calendar event further indicates names of additional event participants and receipts associated with the calendar event.

11. A method comprising:
receiving one or more calendar events indicating an event type, a location, a date, and a time associated with each of the one or more calendar events;
identifying at least one of the one or more calendar events that qualifies for mileage tracking based on the event type associated with the calendar event;
determining that the user is located at the location associated with the qualifying calendar event at the identified date and time associated with the qualifying calendar event; and
providing an estimated mileage calculation based at least in part on the location associated with the qualifying calendar event.

12. The method of claim 11 wherein:
receiving the one or more calendar events comprises querying a calendar application associated with a user profile and retrieve calendar events stored in the calendar application; and
identifying the qualifying calendar event comprises identifying a calendar type associated with the calendar event based on at least one of a calendar application type, a calendar type, and a user indication of an event type.

13. The method of claim 11 further comprising:
tracking the times and locations associated with a plurality of qualifying calendar events in a cloud-based data repository to be ingested by a machine learning system to create at least one additional qualifying calendar event having associated calendar event data; and
notifying the user that the additional qualifying event having the associated calendar event data was created.

14. The method of claim 11 wherein determining that the user is located at the location associated with the qualifying calendar event at the identified time associated with the qualifying calendar event comprises determining that Global Positioning System (GPS) coordinates of a user device correspond to an address at the date and time associated with the qualifying calendar event.

15. The method of claim 11 wherein providing an estimated mileage calculation based at least in part on the location associated with the qualifying calendar event comprises calculating the estimated mileage calculation based on at least one of a distance estimation from a default address associated with the user to an address associated with the qualifying calendar event and a current auto mileage calculating algorithm and displaying the estimated mileage calculation on a user interface to an application.

16. A computing apparatus comprising:
one or more computer readable storage media;
one or more processors operatively coupled with the one or more computer readable storage media; and
program instructions stored on the one or more computer readable storage media that, when read and executed by the one or more processors, direct the one or more processors to at least:
receive one or more events indicating an event type, locations, a date, and a time associated with each of the one or more events;
identify at least one of the one or more events that qualify for mileage tracking based on the event type associated with the event; and
provide an estimated mileage calculation based at least in part on the locations associated with the qualifying event.

17. The computing apparatus of claim 16, wherein the one or more events comprise a transportation event and wherein the locations associated with the qualifying event comprises at least one of a pick-up location and a drop-off location of a trip.

18. The computing apparatus of claim 16, wherein event type, locations, date, and time associated with each of the one or more events are automatically received from a transportation application.

19. The computing apparatus of claim 16, wherein the estimated mileage calculation is provided to a driver of a transportation application based at least in part on the locations associated with the qualifying event, and wherein the estimated mileage calculation is provided to a rider of a transportation application based at least in part on the locations associated with the qualifying event.

20. The computing apparatus of claim 16 wherein the qualifying event further indicates names of additional transportation event riders and receipts associated with the event.
